(19) United States
(12) Patent Application Publication
(10) Pub. No.: US 2024/0205718 A1
(43) Pub. Date: Jun. 20, 2024

(54) CHANNEL MEASUREMENT METHOD AND DEVICE, AND READABLE STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 18/555,837

(22) PCT Filed: Apr. 19, 2021
(86) PCT No.: PCT/CN2021/088157

§ 371 Date: Oct. 17, 2023

(51) Int. Cl. H04W 24/10; H04L 5/00; H04L 27/26

(52) U.S. Cl. CPC H04W 24/10; H04L 5/0094; H04L 27/2672

(57) ABSTRACT

A channel measurement method, the method includes: determining frequency domain measurement accuracy of a terminal during channel measurement; and performing channel measurement according to the frequency domain measurement accuracy.

### CROSS REFERENCE TO RELATED APPLICATION

The present application is a U.S. National Stage of International Application No. PCT/CN2021/088157, filed on Apr. 19, 2021, the contents of all of which are incorporated herein by reference in their entireties for all purposes.

### BACKGROUND

In a new radio (NR), in response to determining that a communication band is in a frequency range (FR) 2, due to fast attenuation of a high-frequency channel, beam-based sending and reception are needed to ensure coverage. An FR2 band uses a continuous bandwidth of up to 400 MHZ.

### SUMMARY

In a first aspect, an example of the disclosure provides a channel measurement method. The method is performed by a terminal device, and including: determining frequency domain measurement accuracy of a terminal during channel measurement; and performing channel measurement according to the frequency domain measurement accuracy.

In a second aspect, an example of the disclosure provides a channel measurement method. The method is performed by an access network device, and includes: determining frequency domain measurement accuracy of a terminal during channel measurement; and receiving a measurement result base on Reference Signal Received Power (RSRP) sent by the terminal, the measurement result including power measurement results of sub-bands obtained by measuring by the terminal based on the frequency domain measurement accuracy.

In a third aspect, an example of the disclosure provides a terminal device, including: a processor; and a transceiver, connected with the processor, where the processor is configured to load and execute executable instructions so as to implement the channel measurement method described in the example of the disclosure.

In a fourth aspect, an example of the disclosure provides an access network device, including: a processor; and a transceiver, connected with the processor, where the processor is configured to load and execute executable instructions so as to implement the channel measurement method described in the example of the disclosure.

In a fifth aspect, an example of the disclosure provides a non-transitory computer readable storage medium, the non-transitory computer readable storage medium stores at least one instruction, at least one program, and a code set or an instruction set, and the at least one instruction, the at least one program, and the code set or the instruction set are loaded and executed by a processor to implement the channel measurement method described in the example of the disclosure.

### BRIEF DESCRIPTION OF THE DRAWINGS

In order to illustrate technical solutions in examples of the disclosure more clearly, accompanying drawings needing to be used in description of the examples will be introduced below briefly. Apparently, the accompanying drawings in the following description are merely some examples of the disclosure, and those skilled in the art can further obtain other accompanying drawings according to these accompanying drawings without inventive efforts.

FIG. 1 shows a schematic diagram of a communication system provided by an example of the disclosure.

FIG. 2 is a schematic diagram of data transmission based on a plurality of TRPs or a plurality of antenna panels (multi-TRP/panel) provided by an example of the disclosure.

FIG. 3 shows a flow diagram of a channel measurement method provided by an example of the disclosure.

FIG. 4 is a flow diagram of a channel measurement method provided by another example of the disclosure.

FIG. 5 is a flow diagram of a channel measurement method provided by another example of the disclosure.

FIG. 6 is a structural block diagram of a channel measurement apparatus provided by an example of the disclosure.

FIG. 7 is a structural block diagram of a channel measurement apparatus provided by another example of the disclosure.

FIG. 8 is a structural block diagram of a communication device provided by an example of the disclosure.

### DETAILED DESCRIPTION

In order to make the objective, technical solutions and advantages of the disclosure clearer, implementations of the disclosure will be described further in detail below with reference to the accompanying drawings.

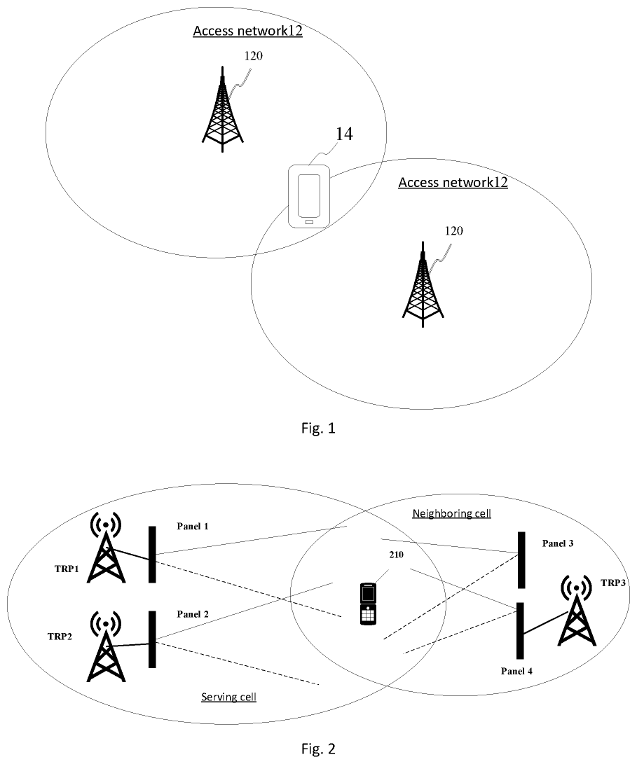

FIG. 1 shows a schematic diagram of a communication system provided by an example of the disclosure. The communication system may include: an access network 12 and a terminal device 14.

The access network 12 includes a plurality of access network devices 120. The access network device 120 may be a base station, and the base station is an apparatus deployed in the access network to provide a wireless communication function for the terminal device. The base station may include various forms of macro base stations, micro base stations, relay stations, access points and the like. In systems adopting different wireless access technologies, names of devices with base station functions may be different. For example, in an LTE system, the device is called eNodeB or eNB; and in a 5G NR-U system, the device is called gNodeB or gNB. With evolution of a communication technology, the description of the “base station” may change. To facilitate the description in the examples of the disclosure, the above apparatuses that provide the wireless communication function for the terminal device 14 are collectively referred to as an access network device.

The terminal device 14 may include various handheld devices, vehicle-mounted devices, wearable devices and computing devices with the wireless communication functions, or other processing devices connected to a wireless modem, as well as various forms of user equipment, mobile stations (MS), terminals (terminal devices) and the like. For the convenience of description, the devices mentioned above are collectively referred to as the terminal device. The access network device 120 and the terminal device 14 communicate with each other through a certain air interface technology, such as a Uu interface.

The technical solutions of the examples of the disclosure may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a new radio (NR) system, an evolution system of the NR system, an LTE-based access to unlicensed spectrum (LTE-U) system, an NR-U system, a universal mobile telecommunication system (UMTS), a worldwide interoperability for microwave access (WiMAX) communication system, wireless local area networks (WLAN), wireless fidelity (WiFi), a next-generation communication system or other communication systems.

Generally speaking, the connection number supported by a traditional communication system is limited and is easy to implement. However, with the development of the communication technology, the mobile communication system will not only support traditional communication, but also support, for example, device to device (D2D) communication, machine to machine (M2M) communication, machine type communication (MTC), vehicle to vehicle (V2V) communication, vehicle to everything (V2X) system and the like. The examples of the disclosure may also be applied to these communication systems.

In a 5G NR system, the above access network device 120 may be replaced with N transmission reception points (TRPs).

FIG. 2 shows a schematic diagram of data transmission based on the plurality of TRPs or a plurality of panels (multi-TRP/panel) provided by an example of the disclosure, as well as a terminal device 210.

The terminal device 210 is located in a serving cell and also in a neighboring cell. Each cell may be covered by more than one TRP. As shown in FIG. 2, the serving cell is jointly covered by a TRP1 and a TRP2, thus increasing a coverage radius of the serving cell. The neighboring cell is covered by a TRP3.

Each TRP may be provided with one or more panels. The orientation of different panels may be different, so that beams in different transmission directions may be sent and received, thus achieving multi-space diversity. The access network device may use the plurality of panels (the plurality of panels may come from the same TRP or different TRPs) to simultaneously send a Physical Downlink Control Channel (PDCCH) to the terminal device 210. In this case, sending directions of the different panels are different, so the terminal device 210 also needs to use the different panels to receive the PDCCH. The access network device needs to indicate different transmission configuration indication (TCI) states to the terminal device, and each TCI state corresponds to a received beam direction on each panel of the terminal device. Through the beam-based sending and reception method above, coverage can be ensured.

Specifically, the access network device may indicate the TCI state through signaling, so as to inform the terminal device 210 of the received beam to be used for reception. Each TCI state corresponds to one reference signal (RS) identifier, the RS may be either a non-zero power channel state information reference signal (CSI-RS), a synchronization signal block (SSB), or a sounding reference signal (SRS).

In the example of the disclosure, illustration is made by implementing the RS as the CSI-RS.

The demand for spectrum in mobile communication is constantly increasing with the development of mobile technology, and a band currently used for 5G millimeter waves is 26.25 GHz to 51.2 GHz. For high-band applications, a continuous ultra-long bandwidth is a major requirement for channel capacity improvement. Currently, an FR2 band of 5G uses a maximum continuous bandwidth of 400 MHZ, while in unauthorized spectrum applications ranging from 51.2 GHz to 66 GHZ, a continuous bandwidth of 2.16 GHz is already used.

In the NR system, the concept of a BandWidth Part (BWP) has been introduced in the design of uplink and downlink communication. One BWP is used for representing a continuous frequency domain resource block (RB) at a given carrier frequency with a given subcarrier spacing.

As the frequency increases, sensitivity of signal transmission to a channel increases. Currently, channel measurement uses the CSI-RS configured by a base station. The terminal performs power measurement for a resource element (RE) configured with the CSI-RS and takes an average value as a power measurement result of the BWP, so that the power measurement result is reported to the access network device, and the reported granularity is based on a width of the entire BWP.

This measuring and reporting method of taking the average value of the reference signal across the entire BWP width eliminates many differences in the channel due to an algorithm of averaging the power on the plurality of REs in a case of large bandwidth. However, for carriers within the same BWP with the large frequency interval, it is not possible to distinguish the differences in the channel well, and the selected channel has a poor communication condition. Especially in a case that the frequency increases, the beam becomes narrower, the beam directionality becomes stronger, and the beam directivity becomes stronger, if the CSI-RS cannot provide good feedback on channel parameters and make channel selection, it will lead to a decrease in system communication quality.

The disclosure relates to the field of communications, in particular to a channel measurement method and a device, and a readable storage medium, which can improve an accuracy rate of channel measurement and selection.

In the example of the present application, frequency domain resources of a BWP when channel measurement is performed are divided to obtain the plurality of sub-bands, such that during channel measurement, the terminal device performs measurement for the sub-bands and obtains measurement results. Thus refining the granularity of channel measurement, improving an accuracy rate of channel selection, and improving the system communication quality.

That is to say, the terminal device first determines frequency domain measurement accuracy during channel measurement, and then performs channel measurement according to the frequency domain measurement accuracy. The terminal device may determine the frequency domain measurement accuracy during channel measurement according to the configuration of the access network device, or the terminal device may determine the frequency domain measurement accuracy during channel measurement according to a definition of a protocol, or, the terminal device may independently determine the frequency domain measurement accuracy during channel measurement and indicate the frequency domain measurement accuracy during its channel measurement to the access network device.

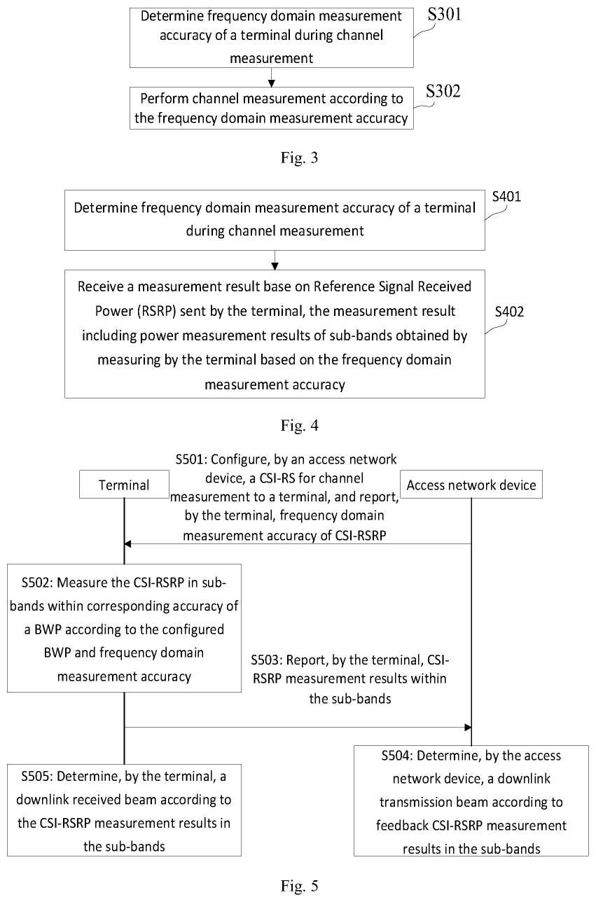

FIG. 3 is a flow diagram of a channel measurement method provided by an example of the disclosure. Illustration is made by taking the execution of this method by a terminal device shown in FIG. 1 as an example, the terminal device is hereinafter referred to as a terminal, and as shown in FIG. 3, the method includes steps S301 and S302.

S301, the frequency domain measurement accuracy of a terminal during channel measurement is determined.

In some examples, the mode for determining the frequency domain measurement accuracy by the terminal includes at least one of the following modes. First, the terminal receives configuration signaling sent by an access network device, the configuration signaling includes a first information field, and the first information field is used for indicating the frequency domain measurement accuracy of the terminal during channel measurement. Second, the terminal determines the frequency domain measurement accuracy according to preliminary definition of the protocol. Third, the terminal determines the frequency domain measurement accuracy according to frequency domain resources during channel measurement.

Whether the terminal confirms the frequency domain measurement accuracy or the access network device determines the frequency domain measurement accuracy, a confirmation mode for the frequency domain measurement accuracy includes the following situations.

In some examples, the frequency domain measurement accuracy includes the frequency domain dividing quantity; or the frequency domain measurement accuracy includes a frequency domain dividing mode.

In response to determining that the frequency domain measurement accuracy is configured by the access network device to the terminal, the frequency domain dividing quantity refers to the dividing quantity of frequency domain resources configured by the access network device to the terminal during channel measurement. In other words, the access network device configures a number to the terminal, and the terminal is configured to divide the frequency domain resources during channel measurement into corresponding quantity of sub-bands according to the number. The frequency domain dividing mode refers to a mode of dividing the frequency domain resources configured by the access network device to the terminal device during channel measurement. For example, the frequency domain dividing mode may be implemented as a frequency domain dividing ratio.

When the frequency domain measurement accuracy is determined by the terminal, a terminal side and an access network device side maintain the same mode of determining the frequency domain measurement accuracy.

In the example of the disclosure, illustration is made by taking an example that the frequency domain measurement accuracy includes the frequency domain dividing quantity.

In some examples, the base station configures a time-frequency resource location of CSI-RS for channel measurement to the terminal, and the base station further needs to configure a channel state information (CSI) report for reporting measurement results after measurement based on the CSI-RS to the terminal, that is, the base station needs to configure channel state information report parameters (CSI-ReportConfig), where, the CSI-ReportConfig is configured with reportFreqConfiguration, which is used for configuring a frequency domain reporting granularity. In the example of the disclosure, frequency domain dividing quantity parameters (CSI-RSRPreport subband Num) are introduced in the reportFreqConfiguration section to indicate the dividing quantity when dividing the frequency domain resources during channel measurement. The frequency domain dividing quantity parameters (CSI-RSRPreport subband Num) are the first information field above.

The terminal receives the configuration signaling sent by the access network device, the configuration signaling includes CSI-ReportConfig, and after acquiring the CSI-RSRreportsubbandNum from it, the quantity when dividing the frequency domain resources during channel measurement is determined. Schematically, in response to determining that a CSI-RSRPreportsubbandNum value is 3, it indicates that the terminal needs to divide the frequency domain resources into three sub-bands for separate measurement during channel measurement.

In some examples, in response to determining that the terminal divides the frequency domain resources according to the frequency domain dividing quantity, at least one of an average dividing mode and a preset dividing mode is included.

The average dividing mode refers to that the terminal divides the frequency domain resources averagely to obtain the corresponding number of sub-bands of the frequency domain dividing quantity. Schematically, a frequency domain resource bandwidth during channel measurement is 1 GHZ, and the frequency domain dividing quantity is 3, thus the frequency domain resources are divided into 3 sub-bands, with the bandwidth of each sub-band being 333 MHZ.

The preset dividing mode refers to that the base station pre-configures a mode of dividing the frequency domain resources for channel measurement. For example, the base station configures the mode that the terminal divides the frequency domain resources into equal lengths with 400 MHz being a basis bandwidth, and the remaining the frequency domain resources after being divided into equal lengths to the quantity that the frequency domain dividing quantity minus one are taken as one sub-band. Schematically, the frequency domain resource bandwidth during channel measurement is 1 GHZ, and the frequency domain dividing quantity is 3. Firstly, two 400 MHZ sub-bands are divided from the frequency domain resources, and the remaining 200 MHz frequency domain resources are taken as one sub-band.

In the example of the disclosure, illustration is made by taking an example of dividing the frequency domain resources in an average dividing mode.

In some examples, the above frequency domain dividing quantity CSI-RSRPreportsubbandNum is determined based on a ratio of the bandwidth of the frequency domain resources to a preset bandwidth. In some examples, the frequency domain dividing quantity CSI-RSRPreportsubbandNum is obtained by rounding up the ratio of the bandwidth of the frequency domain resources to the preset bandwidth, where the frequency domain resources are frequency domain resources of the BWP used for channel measurement.

The preset bandwidth may be a bandwidth value selected by the access network device according to the accuracy requirements of the access network device; or, the preset bandwidth is a minimum continuous bandwidth supported by a current band.

Schematically, the access network device configures CSI-RS time-frequency resources for channel measurement to the terminal, where the BWP used for channel measurement corresponds to a continuous frequency domain resource with a 1 GHz bandwidth, the preset bandwidth is 400 MHZ, and when calculating the frequency domain dividing quantity CSI-RSRPreportsubbandNum, the access network device calculates a numeric value of rounding up 1000/400, resulting in an integer of 3. Thus, in the CSI-ReportConfig configured by the access network device to the terminal, the frequency domain dividing quantity CSI-RSRPreportsubbandNum is configured to be 3.

In some examples, the frequency domain dividing quantity is within a preset range, that is, after calculating the frequency domain dividing quantity, the access network device or the terminal needs to determine the frequency domain dividing quantity within the preset quantity range. Schematically, a value range of the frequency domain dividing quantity is [1, 8]. In response to determining that the frequency domain dividing quantity calculated by the access network device is 9, the numeric value of 8 is taken as the final frequency domain dividing quantity according to the value range of the frequency domain dividing quantity.

In some examples, in response to determining that the access network device configures the frequency domain measurement accuracy in a mode of sending the configuration signaling to the terminal, the access network device sends the configuration signaling to the terminal through PDCCH. The configuration signaling may be implemented as at least one of radio resource control (RRC) signaling, media access control element (MAC CE), or physical layer signaling.

S302, a channel measurement is performed according to the frequency domain measurement accuracy.

In some examples, the terminal first determines the frequency domain resources of a bandwidth part (BWP) during channel measurement, so as to divide the frequency domain resources according to the frequency domain dividing quantity, and perform channel measurement for sub-bands within the divided frequency domain resources.

In some examples, the terminal obtains power measurement results of the sub-bands by performing power measurement for a resource element (RE) carrying a reference signal (CSI-RS) within the divided sub-bands.

For the power measurement process of each sub-band, power of the obtained reference signal is measured and averaged on the sub-band to obtain one power measurement result for each sub-band.

In some examples, the terminal sends the power measurement results of the sub-bands to the access network device, and selects a downlink received beam according to the power measurement results. The access network device is configured to select a downlink transmission beam according to the power measurement results. The terminal selects the downlink received beam according to the power measurement results in the same way as the access network device selects the downlink transmission beam according to the power measurement results. In some examples, the terminal reports a channel state information-reference signal received power (CSI-RSRP) to the access network device after obtaining the power measurement results by perform power measurement for each sub-band, where the CSI-RSRP includes the power measurement result for each sub-band.

In some examples, the terminal averages the obtained reference signal power measurement results on the divided sub-bands, and each sub-band can obtain one CSI-RSRP-subbandi as the measurement result. A value of i is [0, 1, . . . , CSI-RSRPreportsubbandNum−1]. According to the configuration of reportFreq Configuration, the terminal reports the CSI-RSRP-subbandi to the access network device as the power measurement result for each sub-band, so that the access network device selects the downlink transmission beam according to the power measurement result of the sub-band.

Thus, according to the channel measurement method provided by the example of the disclosure, by means of determining the frequency domain measurement accuracy of the terminal during channel measurement, the terminal performs channel measurement according to the frequency domain measurement accuracy. Thereby avoiding a problem of poor channel communication conditions caused by channel measurement under a BWP granularity. Frequency domain resources of the BWP when channel measurement is performed are divided to obtain the plurality of sub-bands, such that during channel measurement, the terminal performs measurement for the sub-bands and obtains measurement results. Thus refining the granularity of channel measurement, improving an accuracy rate of channel selection, and improving system communication quality.

FIG. 4 is a flow diagram of a channel measurement method provided by another example of the disclosure. Illustration is made by taking the execution of this method by an access network device shown in FIG. 1 as an example, and as shown in FIG. 4, the method includes steps S401 and S402.

S401, the frequency domain measurement accuracy of a terminal during channel measurement is determined.

In some examples, the frequency domain measurement accuracy includes the frequency domain dividing quantity, and the frequency domain dividing quantity refers to the quantity of sub-bands obtained by dividing frequency domain resources by the terminal during channel measurement.

In some examples, the frequency domain dividing quantity is the dividing quantity of the frequency domain resources configured by the access network device to the terminal during channel measurement; that is to say, the access network device configures a number to the terminal, and the terminal is configured to divide the frequency domain resources during channel measurement into corresponding quantity of sub-bands according to the number. Alternatively, the frequency domain dividing quantity is the dividing quantity determined by the terminal according to the frequency domain resources during channel measurement.

In some examples, the terminal is configured to averagely divide the BWP frequency domain resources for channel measurement according to the frequency domain dividing quantity. The average dividing mode refers to that the terminal divides the frequency domain resources averagely to obtain the corresponding number of sub-bands of the frequency domain dividing quantity. Schematically, a frequency domain resource bandwidth during channel measurement is 1 GHZ, and the frequency domain dividing quantity is 3, thus the frequency domain resources are divided into 3 sub-bands, with the bandwidth of each sub-band being 333 MHZ.

In some examples, the access network device or the terminal first determines frequency domain resources of a bandwidth part (BWP) of the terminal during channel measurement, and determines the frequency domain dividing quantity according to a ratio of a bandwidth of the frequency domain resources to a preset bandwidth.

In some examples, the frequency domain dividing quantity is obtained by rounding up the ratio of the bandwidth of the frequency domain resources to the preset bandwidth, where the frequency domain resources are frequency domain resources of the BWP used for channel measurement.

The preset bandwidth may be a bandwidth value selected by the access network device according to the accuracy requirements of the access network device; or, the preset bandwidth is a minimum continuous bandwidth supported by a current band.

Schematically, illustration is made by taking an example that the access network device configures the frequency domain measurement accuracy to the terminal, the access network device configures CSI-RS time-frequency resources for channel measurement to the terminal, where the BWP used for channel measurement corresponds to a continuous frequency domain resource with a 1 GHz bandwidth, the preset bandwidth is 400 MHZ, and when calculating the frequency domain dividing quantity CSI-RSRPreportsubbandNum, the access network device calculates a numeric value of rounding up 1000/400, resulting in an integer of 3. Thus, in the CSI-ReportConfig configured by the access network device to the terminal, the frequency domain dividing quantity CSI-RSRPreportsubbandNum is configured to be 3.

In some examples, the frequency domain dividing quantity is within a preset quantity range, that is, the access network device needs to determine the frequency domain dividing quantity within the preset quantity range according to the ratio of the bandwidth of the frequency domain resources to the preset bandwidth. Alternatively, after calculating the frequency domain dividing quantity, the access network device needs to determine the frequency domain dividing quantity within the preset quantity range. Schematically, a value range of the frequency domain dividing quantity is [1, 8]. In response to determining that the frequency domain dividing quantity calculated by the access network device is 9, the numeric value of 8 is taken as the final frequency domain dividing quantity according to the value range of the frequency domain dividing quantity.

S402, a measurement result base on Reference Signal Received Power (RSRP) sent by the terminal is received, and the measurement result includes power measurement results of sub-bands obtained by measuring by the terminal based on the frequency domain measurement accuracy.

The terminal is configured to divide the frequency domain resources for channel measurement according to the frequency domain measurement accuracy, obtain at least two sub-bands, and perform power measurement for each sub-band.

In some examples, the terminal obtains power measurement results of the sub-bands by performing power measurement for a resource element (RE) carrying a reference signal (CSI-RS) within the divided sub-bands.

For the power measurement process of each sub-band, power of the obtained reference signal is measured and averaged on the sub-band to obtain one power measurement result for each sub-band.

In some examples, the terminal sends the power measurement results of the sub-bands to the access network device, and the access network device selects a downlink transmission beam according to the power measurement results. The terminal selects the downlink received beam according to the power measurement results in the same way as the access network device selects the downlink transmission beam according to the power measurement results.

In some examples, the terminal averages the obtained reference signal power measurement results on the divided sub-bands, and each sub-band can obtain one power measurement result. The terminal reports the power measurement result of each sub-band to the access network device, so that the access network device selects the downlink transmission beam according to the power measurement result of the sub-band.

Thus, according to the channel measurement method provided by the example of the disclosure, by means of determining the frequency domain measurement accuracy of the terminal during channel measurement, the terminal performs channel measurement according to the frequency domain measurement accuracy. Thus avoiding a problem of poor channel communication conditions caused by channel measurement under a BWP granularity. Frequency domain resources of the BWP when channel measurement is performed are divided to obtain the plurality of sub-bands, such that during channel measurement, the terminal performs measurement for the sub-bands and obtains measurement results. Thereby refining the granularity of channel measurement, improving an accuracy rate of channel selection, and improving system communication quality.

FIG. 5 is a flow diagram of a channel measurement method provided by an example of the present application. Illustration is made by taking the application of this method in a communication system shown in FIG. 1 as an example, and as shown in FIG. 5, the method includes steps S501-S505.

S501, an access network device configures a CSI-RS for channel measurement to a terminal, and the terminal reports frequency domain measurement accuracy of the CSI-RSRP. That is, the access network device configures CSI-RS time-frequency resources for channel measurement to the terminal, such as a downlink BWP of the CSI-RS for channel measurement occupying a continuous 1 GHZ bandwidth.

In some examples, after the access network device determines a bandwidth corresponding to the BWP, a preset bandwidth is determined to be 400 MHZ, and the frequency domain measurement accuracy is calculated according to the bandwidth of the BWP and the preset bandwidth. That is, the frequency domain dividing quantity is a numeric value of rounding up a ratio of the BWP bandwidth 1000 to the preset bandwidth 400, and an integer obtained is 3.

Thus, the access network device configures video resources of the CSI-RS for channel measurement to the terminal, as well as the frequency domain measurement accuracy, i.e. the frequency domain dividing quantity “3”.

In some examples, in response to determining that a base station configures CSI-ReportConfig, CSI-RSRPreportsubbandNum is introduced as the frequency domain dividing quantity when configuring reportFreqConfiguration. In some examples, the base station configures CSI-RSRPreportsubbandNum in the reportFreqConfiguration of CSI-ReportConfig to be equal to 3.

Next in S502, the terminal measures CSI-RSRP in sub-bands within the corresponding accuracy of the BWP according to the configured BWP and frequency domain measurement accuracy.

In some examples, the terminal receives CSI-ReportConfig configured by the base station and obtains the CSI-RSRPreportsubbandNum in the reportFreqConfiguration to be equal to 3, and the terminal divides the downlink BWP frequency domain resources into three sub-bands.

In some examples, when dividing the downlink BWP frequency domain resources, the terminal allocates the BWP bandwidth of 1 GHz in an average mode for three sub-bands, that is, each sub-band is 333 MHZ.

The terminal divides the BWP frequency domain resources to obtain at least two sub-bands, and performs power measurement for each sub-band.

Schematically, illustration is made by taking the division of the three sub-bands as an example, the three sub-bands include a sub-band a, a sub-band b, and a sub-band c, which respectively occupy 333 MHz of BWP frequency domain resources. The terminal performs power measurement for each RE of the reference signal (CSI-RS) obtained on these sub-bands, and averages power measurement results of the RE. Each sub-band may obtain one CSI-RSRP-subband as the measurement result, for example: the sub-band a obtains CSI-RSRP-subband1 as the power measurement result through measurement, the sub-band b obtains CSI-RSRP-subband2 as the power measurement result through measurement, the sub-band c obtains CSI-RSRP-subband3 as the power measurement result through measurement, and there are three measurement results in total.

Then, in S503, the terminal reports the CSI-RSRP measurement results within the sub-bands.

In some examples, the terminal reports the CSI-RSRP measurement results on a physical uplink control channel (PUCCH). The CSI-RSRP measurement results include the measurement results CSI-RSRP-subband corresponding to the sub-bands.

Illustration is made by taking the above three sub-bands as examples, the CSI-RSRP measurement results include the power measurement result CSI-RSRP-subband1 for the sub-band a, the CSI-RSRP-subband2 for the sub-band b, and the CSI-RSRP-subband3 for the sub-band c.

Then, in S504, the access network device determines the downlink transmission beam according to the feedback CSI-RSRP measurement results in the sub-bands.

In some examples, the access network device comprehensively evaluates channel quality corresponding to the BWP used for channel measurement according to the feedback CSI-RSRP measurement results in each sub-and in the BWP, so as to select the downlink transmission beam.

Schematically, when the power measurement results corresponding to all the sub-bands in the BWP meet a power measurement threshold, it is determined that the channel quality corresponding to the BWP is better, and the downlink transmission beam corresponding to the BWP where the power measurement results corresponding to all the sub-bands meet the power measurement threshold is selected.

Finally, in S505, the terminal determines the downlink received beam according to the CSI-RSRP measurement results in the sub-bands.

In some examples, the terminal determines the downlink received beam according to the CSI-RSRP in the same way as the access network device selects the downlink transmission beam according to the CSI-RSRP measurement results.

Thus, according to the channel measurement method provided by the example of the disclosure, by means of configuring, by the access network device, the frequency domain measurement accuracy of the terminal during channel measurement, the terminal performs channel measurement according to the frequency domain measurement accuracy, thus avoiding a problem of poor channel communication conditions caused by channel measurement under a BWP granularity. Frequency domain resources of the BWP when channel measurement is performed are divided to obtain the plurality of sub-bands, such that during channel measurement, the terminal performs measurement for the sub-bands and obtains measurement results, thus refining the granularity of channel measurement, improving an accuracy rate of channel selection, and improving system communication quality.

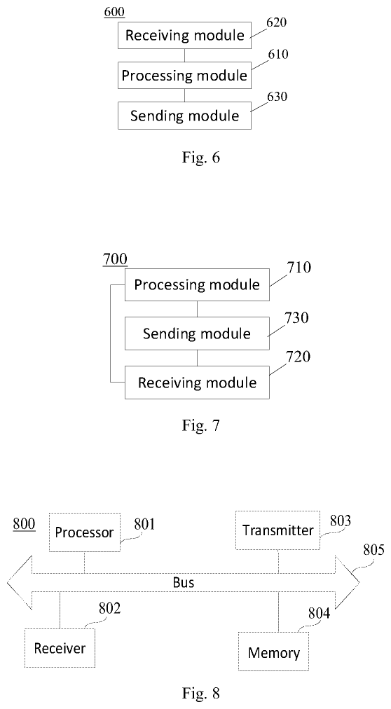

FIG. 6 is a structural block diagram of a channel measurement apparatus 600 provided by an example of the present application. The apparatus 600 is applied to a terminal, and as shown in FIG. 6, the apparatus 600 includes any combination of a processing module 610, a receiving module 620 and a sending module 630.

The processing module 610 is configured to determine frequency domain measurement accuracy of a terminal during channel measurement. The processing module 610 is further configured to perform channel measurement according to the frequency domain measurement accuracy.

The receiving module 620 is configured to receive configuration signaling. The configuration signaling including a first information field, the first information field being used for indicating the frequency domain measurement accuracy of the terminal during channel measurement. In addition or alternatively, the processing module 610 is configured to determine the frequency domain measurement accuracy according to frequency domain resources during channel measurement.

In a possible example, the frequency domain measurement accuracy includes the frequency domain dividing quantity.

In a possible example, the processing module 610 is further configured to determine frequency domain resources of a bandwidth part (BWP) during channel measurement; divide the frequency domain resources according to the frequency domain dividing quantity; and perform channel measurement for sub-bands within the divided frequency domain resources.

In a possible example, the processing module 610 is further configured to divide the frequency domain resources evenly according to the frequency domain dividing quantity.

In a possible example, the frequency domain dividing quantity is determined according to a ratio of a bandwidth of the frequency domain resources to a preset bandwidth.

In a possible example, the frequency domain dividing quantity is obtained by rounding up the ratio of the bandwidth of the frequency domain resources to the preset bandwidth.

In a possible example, the frequency domain dividing quantity is within a preset quantity range.

In a possible example, the processing module 610 is further configured to obtain power measurement results of the sub-bands by performing power measurement for a resource element (RE) carrying a reference signal (CSI-RS) within the divided sub-bands.

In a possible example, the receiving module 620 is further configured to select a downlink received beam according to the power measurement results.

The sending module 630 is configured to send the power measurement results of the sub-bands to an access network device, the access network device being configured to select a downlink transmission beam according to the power measurement results.

Thus, according to the channel measurement apparatus provided by the example of the disclosure, by means of determining the frequency domain measurement accuracy of the terminal during channel measurement, the terminal performs channel measurement according to the frequency domain measurement accuracy. This avoids the problem of poor channel communication conditions caused by channel measurement under a BWP granularity. Frequency domain resources of the BWP when channel measurement is performed are divided to obtain the plurality of sub-bands, such that during channel measurement, the terminal performs measurement for the sub-bands and obtains measurement results. Therefore, refining the granularity of channel measurement, improving an accuracy rate of channel selection, and improving system communication quality.

FIG. 7 is a structural block diagram of a channel measurement apparatus 700 provided by an example of the present application. The apparatus 700 is applied to an access network device, and as shown in FIG. 7, the apparatus 700 includes any combination of a processing module 710, a receiving module 720, and a sending module 730. The processing module 710 is configured to determine frequency domain measurement accuracy of a terminal during channel measurement.

The receiving module 720 is configured to receive a measurement result base on Reference Signal Received Power (RSRP) sent by the terminal, the measurement result including power measurement results of sub-bands obtained by measuring by the terminal based on the frequency domain measurement accuracy.

In a possible example, the frequency domain measurement accuracy includes the frequency domain dividing quantity.

In a possible example, the processing module 710 is further configured to determine frequency domain resources of a bandwidth part (BWP) of the terminal during channel measurement; and determine the frequency domain dividing quantity according to a ratio of a bandwidth of the frequency domain resources to a preset bandwidth.

In a possible example, the processing module 710 is further configured to obtain the frequency domain dividing quantity by rounding up the ratio of the bandwidth of the frequency domain resources to the preset bandwidth.

In a possible example, the processing module 710 is further configured to determine the frequency domain dividing quantity within a preset quantity range according to the ratio of the bandwidth of the frequency domain resources to the preset bandwidth.

The sending module 730 is configured to send configuration signaling to the terminal, the configuration signaling including a first information field, the first information field being used for indicating the frequency domain measurement accuracy.

In a possible example, the sending module 730 is further configured to select a downlink transmission beam based on the power measurement results of the sub-bands.

Thus, according to the channel measurement apparatus provided by the example of the disclosure, by means of determining the frequency domain measurement accuracy of the terminal during channel measurement, the terminal performs channel measurement according to the frequency domain measurement accuracy. Thereby avoiding a problem of poor channel communication conditions caused by channel measurement under a BWP granularity. Frequency domain resources of the BWP when channel measurement is performed are divided to obtain the plurality of sub-bands, such that during channel measurement, the terminal performs measurement for the sub-bands and obtains measurement results, thus refining the granularity of channel measurement, improving an accuracy rate of channel selection, and improving system communication quality.

FIG. 8 shows a schematic structural diagram of a communication device 800 (a terminal device or an access network device) provided by an example of the disclosure. The communication device 800 includes: a processor 801, a receiver 802, a transmitter 803, a memory 804, and a bus 805.

The processor 801 includes one or more processing cores, and the processor 801 executes various functional applications and information processing by running software programs and modules.

The receiver 802 and the transmitter 803 may be implemented as one communication component, which may be a communication chip.

The memory 804 is connected with the processor 801 through the bus 805. The memory 804 may be configured to store at least one instruction, and the processor 801 is configured to execute the at least one instruction, so as to implement various steps in the above method examples.

Additionally, the memory 804 may be implemented by any type of volatile or nonvolatile storage devices or their combinations, and the volatile or nonvolatile storage devices include but are not limited to: a magnetic disk or an optical disk, an electrically erasable programmable read only memory (EEPROM), an erasable programmable read only memory (EPROM), a static random access memory (SRAM), a read-only memory (ROM), a magnetic memory, a flash memory, and a programmable read-only memory (PROM).

An example of the disclosure further provides a channel measurement system, and the system includes a terminal device and an access network device.

The terminal device includes a channel measurement apparatus provided by the example shown in FIG. 6.

The access network device includes the channel measurement apparatus provided by the example shown in FIG. 7.

An example of the disclosure further provides a computer readable storage medium. The computer readable storage medium stores at least one instruction, at least one program, a code set or an instruction set. The at least one instruction, the at least one program, the code set or the instruction set is loaded and executed by a processor to implement the steps executed by the terminal in the channel measurement methods provided by the method examples above.

It is to be understood that “a plurality of” mentioned here refers to two or more. “And/or” describes an association relationship of an association object, and represents that there may be three kinds of relationships, for example, A and/or B, may represent: A exists alone, A and B exist at the same time, and B exists alone. A character “/” generally represents that the previous and next association objects are in an “or” relationship.

In a first aspect, an example of the disclosure provides a channel measurement method performed by a terminal device, and including: determining frequency domain measurement accuracy of a terminal during channel measurement; and performing channel measurement according to the frequency domain measurement accuracy.

In a possible example, determining the frequency domain measurement accuracy of the terminal during channel measurement includes: receiving configuration signaling, the configuration signaling including a first information field, the first information field being used for indicating the frequency domain measurement accuracy of the terminal during channel measurement; or determining the frequency domain measurement accuracy according to frequency domain resources during channel measurement.

In a possible example, the frequency domain measurement accuracy includes a frequency domain dividing quantity.

In a possible example, performing channel measurement according to the frequency domain measurement accuracy includes: determining frequency domain resources of a bandwidth part (BWP) during channel measurement; dividing the frequency domain resources according to the frequency domain dividing quantity; and performing channel measurement for sub-bands within the divided frequency domain resources.

In a possible example, dividing the frequency domain resources according to the frequency domain dividing quantity includes: dividing the frequency domain resources evenly according to the frequency domain dividing quantity.

In a possible example, the frequency domain dividing quantity is determined according to a ratio of a bandwidth of the frequency domain resources to a preset bandwidth.

In a possible example, the frequency domain dividing quantity is obtained by rounding up the ratio of the bandwidth of the frequency domain resources to the preset bandwidth.

In a possible example, the frequency domain dividing quantity is within a preset quantity range.

In a possible example, performing channel measurement for the sub-bands within the divided frequency domain resources includes: obtaining power measurement results of the sub-bands by performing power measurement for a resource element (RE) carrying a reference signal (CSI-RS) within the divided sub-bands.

In a possible example, the method further includes: selecting a downlink received beam according to the power measurement results.

In a possible example, the method further includes: sending the power measurement results of the sub-bands to an access network device, the access network device being configured to select a downlink transmission beam according to the power measurement results.

In a second aspect, an example of the disclosure provides a channel measurement method, performed by an access network device, and including: determining frequency domain measurement accuracy of a terminal during channel measurement; and receiving a measurement result base on Reference Signal Received Power (RSRP) sent by the terminal, the measurement result including power measurement results of sub-bands obtained by measuring by the terminal based on the frequency domain measurement accuracy.

In a possible example, the frequency domain measurement accuracy includes the frequency domain dividing quantity.

In a possible example, determining the frequency domain measurement accuracy of the terminal during channel measurement includes: determining frequency domain resources of a bandwidth part (BWP) of the terminal during channel measurement; and determining the frequency domain dividing quantity according to a ratio of a bandwidth of the frequency domain resources to a preset bandwidth.

In a possible example, determining the frequency domain dividing quantity according to the ratio of the bandwidth of the frequency domain resources to the preset bandwidth includes: obtaining the frequency domain dividing quantity by rounding up the ratio of the bandwidth of the frequency domain resources to the preset bandwidth.

In a possible example, determining the frequency domain dividing quantity according to the ratio of the bandwidth of the frequency domain resources to the preset bandwidth includes: determining the frequency domain dividing quantity within a preset quantity range according to the ratio of the bandwidth of the frequency domain resources to the preset bandwidth.

In a possible example, the method further includes: sending configuration signaling to the terminal, the configuration signaling including a first information field, the first information field being used for indicating the frequency domain measurement accuracy.

In a possible example, the method further includes: selecting a downlink transmission beam based on the power measurement results of the sub-bands.

In a third aspect, an example of the disclosure provides a channel measurement apparatus, performed by a terminal, and including: a processing module, configured to determine frequency domain measurement accuracy of a terminal during channel measurement; and the processing module being further configured to perform channel measurement according to the frequency domain measurement accuracy.

In a possible example, the apparatus further includes: a receiving module, configured to receive configuration signaling, the configuration signaling including a first information field, the first information field being used for indicating the frequency domain measurement accuracy of the terminal during channel measurement; or, the processing module being further configured to determine the frequency domain measurement accuracy according to frequency domain resources during channel measurement.

In a possible example, the frequency domain measurement accuracy includes the frequency domain dividing quantity.

In a possible example, the processing module is further configured to determine frequency domain resources of a bandwidth part (BWP) during channel measurement; divide the frequency domain resources according to the frequency domain dividing quantity; and perform channel measurement for sub-bands within the divided frequency domain resources.

In a possible example, the processing module is further configured to divide the frequency domain resources evenly according to the frequency domain dividing quantity.

In a possible example, the frequency domain dividing quantity is determined according to a ratio of a bandwidth of the frequency domain resources to a preset bandwidth.

In a possible example, the frequency domain dividing quantity is obtained by rounding up the ratio of the bandwidth of the frequency domain resources to the preset bandwidth.

In a possible example, the frequency domain dividing quantity is within a preset quantity range.

In a possible example, the processing module is further configured to obtain power measurement results of the sub-bands by performing power measurement for a resource element (RE) carrying a reference signal (CSI-RS) within the divided sub-bands.

In a possible example, the receiving module is further configured to select a downlink received beam according to the power measurement results.

In a possible example, the apparatus further includes: a sending module, configured to send the power measurement results of the sub-bands to an access network device, the access network device being configured to select a downlink transmission beam according to the power measurement results.

In a fourth aspect, an example of the disclosure provides a channel measurement apparatus, performed by an access network device, and including: a processing module, configured to determine frequency domain measurement accuracy of a terminal during channel measurement; and a receiving module, configured to receive a measurement result base on Reference Signal Received Power (RSRP) sent by the terminal, the measurement result including power measurement results of sub-bands obtained by measuring by the terminal based on the frequency domain measurement accuracy.

In a possible example, the frequency domain measurement accuracy includes the frequency domain dividing quantity.

In a possible example, the processing module is further configured to determine frequency domain resources of a bandwidth part (BWP) of the terminal during channel measurement; and determine the frequency domain dividing quantity according to a ratio of a bandwidth of the frequency domain resources to a preset bandwidth.

In a possible example, the processing module is further configured to obtain the frequency domain dividing quantity by rounding up the ratio of the bandwidth of the frequency domain resources to the preset bandwidth.

In a possible example, the processing module is further configured to determine the frequency domain dividing quantity within a preset quantity range according to the ratio of the bandwidth of the frequency domain resources to the preset bandwidth.

In a possible example, the apparatus further includes: a sending module, configured to send configuration signaling to the terminal, the configuration signaling including a first information field, the first information field being used for indicating the frequency domain measurement accuracy.

In a possible example, the sending module is further configured to select a downlink transmission beam based on the power measurement results of the sub-bands.

In a fifth aspect, an example of the disclosure provides a terminal device, including: a processor; and a transceiver, connected with the processor, where the processor is configured to load and execute executable instructions so as to implement the channel measurement method described in the example of the disclosure.

In a sixth aspect, an example of the disclosure provides an access network device, including:

a processor; and a transceiver, connected with the processor, where the processor is configured to load and execute executable instructions so as to implement the channel measurement method described in the example of the disclosure.

In a seventh aspect, an example of the disclosure provides a non-transitory computer readable storage medium, the non-transitory computer readable storage medium stores at least one instruction, at least one program, and a code set or an instruction set, and the at least one instruction, the at least one program, and the code set or the instruction set are loaded and executed by a processor to implement the channel measurement method described in the example of the disclosure.

The beneficial effects brought by the technical solutions provided by the examples of the disclosure at least include: by means of determining the frequency domain measurement accuracy of the terminal during channel measurement, the terminal performs channel measurement according to the frequency domain measurement accuracy, thus avoiding a problem of poor channel communication conditions caused by channel measurement under a BWP granularity. Frequency domain resources of a BWP when channel measurement is performed are divided to obtain the plurality of sub-bands, such that during channel measurement, the terminal performs measurement for the sub-bands and obtains measurement results, thus refining the granularity of channel measurement, improving an accuracy rate of channel selection, and improving system communication quality.

Those of skill in the art will easily figure out other implementation solutions of the disclosure after considering the specification and practicing the invention disclosed here. The disclosure intends to cover any transformation, usage or adaptive change of the disclosure, and these transformations, usages or adaptive changes conform to a general principle of the disclosure and include common general knowledge or conventional technical means in the technical field not disclosed by the disclosure. The specification and the examples are merely regarded as being for example, and the true scope and spirit of the disclosure are indicated by the following claims.

It is to be understood that the disclosure is not limited to the exact structure that has been described above and shown in the accompanying drawings, and that various modifications and changes may be made without departing from the scope of the disclosure. The scope of the disclosure is limited merely by the appended claims.

1. A channel measurement method, performed by a terminal, and comprising:
determining frequency domain measurement accuracy of a terminal during channel measurement; and
performing channel measurement according to the frequency domain measurement accuracy.

2. The method according to claim 1, wherein determining the frequency domain measurement accuracy of the terminal during channel measurement comprises:
receiving configuration signaling, the configuration signaling comprising a first information field, the first information field being used for indicating the frequency domain measurement accuracy of the terminal during channel measurement; or,
determining the frequency domain measurement accuracy according to frequency domain resources during channel measurement.

3. The method according to claim 1, wherein the frequency domain measurement accuracy comprises a frequency domain dividing quantity.

4. The method according to claim 3, wherein performing the channel measurement according to the frequency domain measurement accuracy comprises:
determining frequency domain resources of a bandwidth part (BWP) during channel measurement;
dividing the frequency domain resources according to the frequency domain dividing quantity; and
performing channel measurement for sub-bands within the divided frequency domain resources.

5. The method according to claim 4, wherein dividing the frequency domain resources according to the frequency domain dividing quantity comprises:
dividing the frequency domain resources evenly according to the frequency domain dividing quantity.

6. The method according to claim 4, wherein the frequency domain dividing quantity is determined according to a ratio of a bandwidth of the frequency domain resources to a preset bandwidth.

7. The method according to claim 6, wherein the frequency domain dividing quantity is obtained by rounding up the ratio of the bandwidth of the frequency domain resources to the preset bandwidth.

8. The method according to claim 3, wherein the frequency domain dividing quantity is within a preset quantity range.

9. The method according to claim 4, wherein performing the channel measurement for the sub-bands within the divided frequency domain resources comprises:
obtaining power measurement results of the sub-bands by performing power measurement for a resource element (RE) carrying a reference signal (CSI-RS) within the sub-bands.

10. The method according to claim 9, further comprising:
selecting a downlink received beam according to the power measurement results.

11. The method according to claim 9, further comprising:
sending the power measurement results of the sub-bands to an access network device, the access network device being configured to select a downlink transmission beam according to the power measurement results.

12. A channel measurement method, performed by an access network device, and comprising:
determining frequency domain measurement accuracy of a terminal during channel measurement; and
receiving a measurement result base on Reference Signal Received Power (RSRP) sent by the terminal, the measurement result comprising power measurement results of sub-bands obtained by measuring by the terminal based on the frequency domain measurement accuracy.

13. (canceled)

14. The method according to claim 12, wherein determining the frequency domain measurement accuracy of the terminal during channel measurement comprises:
determining frequency domain resources of a bandwidth part (BWP) of the terminal during channel measurement; and
determining a frequency domain dividing quantity according to a ratio of a bandwidth of the frequency domain resources to a preset bandwidth.

15. The method according to claim 14, wherein determining the frequency domain dividing quantity according to the ratio of the bandwidth of the frequency domain resources to the preset bandwidth comprises:
obtaining the frequency domain dividing quantity by rounding up the ratio of the bandwidth of the frequency domain resources to the preset bandwidth.

16. The method according to claim 14, wherein determining the frequency domain dividing quantity according to the ratio of the bandwidth of the frequency domain resources to the preset bandwidth comprises:
determining the frequency domain dividing quantity within a preset quantity range according to the ratio of the bandwidth of the frequency domain resources to the preset bandwidth.

17. The method according to claim 12, further comprising:
sending configuration signaling to the terminal, the configuration signaling comprising a first information field, and the first information field being used for indicating the frequency domain measurement accuracy.

18. The method according to claim 17, further comprising:
selecting a downlink transmission beam based on the power measurement results of the sub-bands.

19-36. (canceled)

37. A terminal device, comprising:
a processor; and
a transceiver, communicatively connected to the processor, wherein
the processor is configured to:
determine frequency domain measurement accuracy of a terminal during channel measurement; and
perform channel measurement according to the frequency domain measurement accuracy.

38. An access network device, comprising:
a processor; and
a transceiver, communicatively connected to the processor, wherein
the processor is configured to load and execute executable instructions so as to implement the channel measurement method according to claim 12.

39. A non-transitory computer readable storage medium, storing at least one instruction, at least one program, and a code set or an instruction set, and the at least one instruction, the at least one program, and the code set or the instruction set being loaded and executed by a processor to implement the channel measurement method according to claim 1.
